(19) United States
(12) Patent Application Publication
(10) Pub. No.: US 2008/0169386 A1
(43) Pub. Date: Jul. 17, 2008

(54) Cable Clip

(76) Inventors: Lulu Schnyder, Falterbo (SE); Rolf Schnyder, Falterbo (SE); Kent Sandstrom, Malmo (SE)

Correspondence Address: Steven S Payne;Arator IP Law Group PLLC, P.O.Box 65024, Washington, DC, 20035, US

(21) Appl. No.: 11/793,179

(22) PCT Filed: Dec. 13, 2005
(86) PCT No.: PCT/SE05/01899

§ 371 Date: Mar. 5, 2008

(30) Foreign Application Priority Data
Dec. 13, 2004 (SE) 0403033-4

(51) Int. Cl. F16B 2/20; H02G 3/32; E04F 19/04

(52) U.S. Cl. 248/71

(57) ABSTRACT

The present invention concerns a method of attaching cables to a skirting board (7) or the like. It also concerns a cable clip (1, 11, 21, 31) and a tool (40) to be used in the method. The cable clip (1, 11, 21, 31) has a head (2, 12, 22, 32) with a recess (3, 13, 23, 33) to receive a cable. Furthermore, the cable clip (1, 11, 21, 31) has a relatively thin insert part (4, 14, 24, 34) with a bevelled, pointed and/or rounded lower end (5, 15, 25, 35) for insertion between the skirting board (7) and a wall (8). Each cable clip (1, 11, 21, 31) has one or more flexible parts (6, 16, 26, 36) giving a retaining force when installed. If needed a tool (40) having a pointed and bevelled lower end (44) is inserted between the skirting boar (7) and the wall (8). By means of the tool (40) the skirting board is bent out just enough to give access for a cable clip (1, 11, 21, 31) between the skirting board (7) and the wall (8).

### TECHNICAL FIELD

The present invention concerns cable clips to be inserted between a skirting board, baseboard or the like and a wall. It also concerns a method and a tool for installation of cables by means of the cable clips.

### PRIOR ART

To keep cables of different kinds tidy and in place it is common to attach the cables to skirting boards or the like by means of some kind of clip, normally nailed to the skirting board. By means of the cable clips, cables for computers, telephones, television, radio, lighting etc. may be attached to a skirting board or the like, to keep the cables close to a wall. The most common cable clips have a nail or pin that is to be hammered down into the skirting board. The nails or the like will leave marks on the skirting board if the cable is removed in a later stage. The pins are quite small and it may be tricky to hammer them down, without leaving marks of the hammer on the skirting board or the wall. Thus, there is a need for cable clips that are easy to install and that may be installed and removed without leaving any marks on the skirting board or the wall.

### SUMMARY OF THE INVENTION

The cable clips according to the present invention are to be installed by simply being pushed down between a wall and a skirting board, placed at a floor. A person skilled in the art realises that the clips may be used anywhere, such as around doors and windows as well as at ceilings, as long as there is a distance between a wall or the like and any kind of frame etc. Thus, the part of each cable clip to be inserted between the wall and the skirting board should be as thin as possible, and still be stiff enough for insertion. As a cable sometimes may be difficult to get straight, due to inherent tensions, the clips should have a retaining power after installation. According to the present invention this is achieved in that each clip has one or more flexible parts giving a retaining force after installation. The flexible parts will be pressed against the wall and/or the skirting board. The flexible parts also help in taking up possible distances between the wall and the skirting board. It is quite common that the wall and the skirting board are not completely straight, giving small spaces between the skirting board and the wall.

By using the cable clips of the present invention it is possible to take up the cable by just lifting up the cable clips, against the force of the flexible part or parts. Normally, the cable clips will leave no marks on the wall or the skirting board. The cable clips may be reused for a new installation.

Sometimes the distance between the wall and the skirting board is too small to insert even a thin cable clip. For such an instance a tool has been developed, making it possible to gently bend out the skirting board from the wall just enough to make it possible to insert a cable clip between the wall and the skirting board.

Further advantages and objects of the present invention will be obvious for a person skilled in the art when reading the detailed description below of at present preferred embodiments.

### BRIEF DESCRIPTION OF THE DRAWINGS

The invention will be explained further below by way of examples and with reference to the enclosed drawings. In the drawings:

FIG. 1 is a perspective view of a cable clip according to the present invention,

FIG. 2 is a side view of the cable clip of FIG. 1,

FIG. 3 is a sketch illustrating the intended use of a cable clip according to the present invention,

FIGS. 4 to 6 are examples of further cable clips according to the present invention, and

FIG. 7 is a perspective view of a tool possible to use with the cable clips of the present invention.

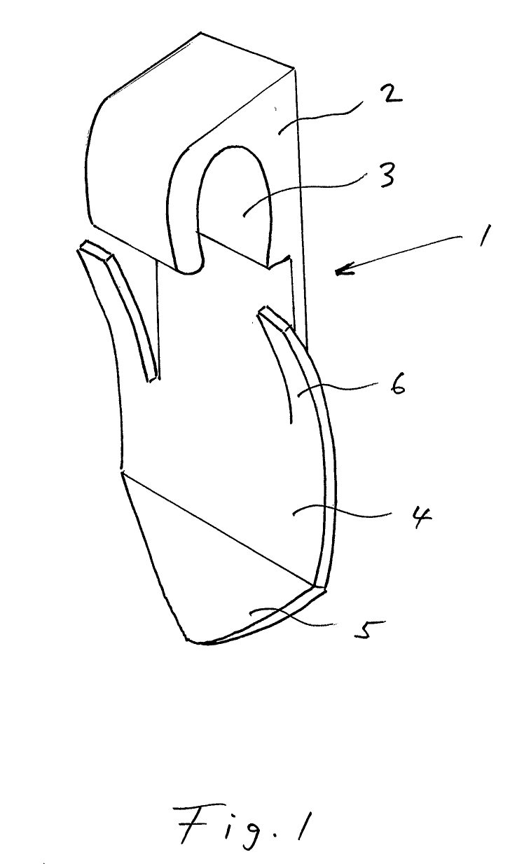

### DETAILED DESCRIPTION OF PREFERRED EMBODIMENTS

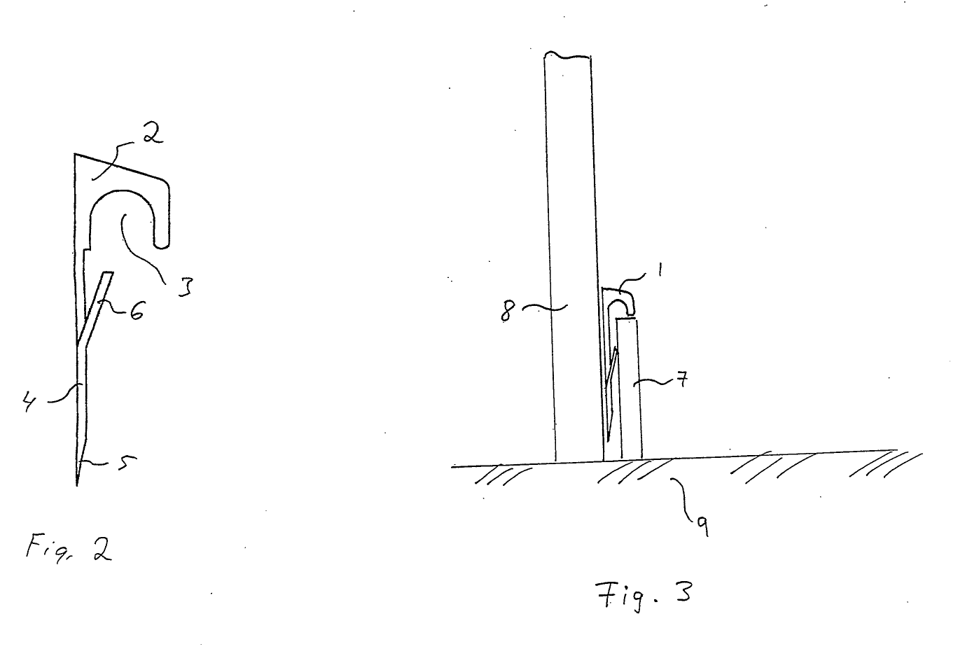

When used in this description the expressions “horizontal”, “vertical”, “upper”, “lower” and similar expressions refer to directions in normal use of the different parts and as indicated in FIG. 3.

One cable clip 1 according to a first embodiment of the present invention has a head 2 at the upper end. A recess 3 is formed inside the head 2 for receiving a cable (not shown). The recess 3 is open downwards in use. Below the head 2 the cable clip 1 has an insert part 4, having a bevelled lower end 5. The insert part 4 is to be slid down between a skirting board 7 and a wall 8, as indicated in FIG. 3. To be able to be slid down the insert part 4 should be as thin as possible but still be stiff enough to be inserted. The head 2 extends forward in relation to the insert part 4 in a direction directed away from the wall 8 when installed. By means of the bevelled end 5 of the insert part 4 insertion of the cable clip 1 is facilitated.

Furthermore, the cable clip 1 has two flexible parts 6 in form of strips at each side of the insert part 4. The flexible parts are integrated with the insert part 4 in this embodiment. Said flexible parts 6 are bent and have a function as a spring. Thus, they will give after for pressure and return to their original position if the pressure is removed. The function of the flexible parts 6 are to take up any distance between the wall 8 and the skirting board 7 and to give a retaining force to the cable clip 1. In the shown example the flexible parts 6 are directed forward, i.e. towards the skirting board 7 when installed. A person skilled in the art realises that the flexible parts 6 may be bent in any directions giving the same function. Thus, the flexible parts 6 may both be directed towards the wall 8 when installed or they may be bent in different directions, i.e. one flexible part 6 directed towards the wall 8 and the other towards the skirting board 7 when installed.

As indicated in FIG. 3 the clips 1 of the present invention are intended for use at skirting boards 7 fixed to a wall 8 adjacent a floor 9, as is well known. However, as indicated above the use of the cable clips are not limited to adjacent floors, they may also be used at doors, windows, ceilings or the like. The cable clips 1 are easy to install by only being slid down between the wall 8 and the skirting board 7. The cable clips 1 are also relatively easy to take away by just lifting them up, overcoming the force of the flexible parts 6 abutting the skirting board 7 and/or the wall 8. Thus, the cable clips 1 may be reused a number of times and do not leave any marks on the skirting board 7 or wall 8.

Often the wall 8 and/or the skirting board 7 are not perfectly straight leaving a space between the skirting board 7 and the wall 8. If such spaces are to small to insert a cable clip 1 a special tool 40 may be used to bend out the skirting board 7 temporarily while a cable clip 1 is inserted. The special tool 40 shown in FIG. 7 is one example of an embodiment for such a tool. A person skilled in the art realises that the tool may have any design as long as it fulfils the wanted features, i.e. bending out the skirting board 7 a short distance without leaving any marks on the wall 8 or the skirting board 7. The tool 40 has a insert part 41 bent downwards, which is to be inserted between the wall 8 and the skirting board 7, a horizontal part 42 and a handle 43 at the end, which handle 43 is bent slightly upwards and should be gripped by the person inserting the cable clips 1. To facilitate insertion the lower end 44 of the insert part 41 is pointed and bevelled. Furthermore, to insert the tool 40 it is possible to use e.g. a hammer on the horizontal part 42. When the tool 40 has been inserted between the wall 8 and the skirting board 7 the handle 43 is pressed downwards or upwards just enough to give access for a cable clip 1 between the wall 8 and the skirting board 7.

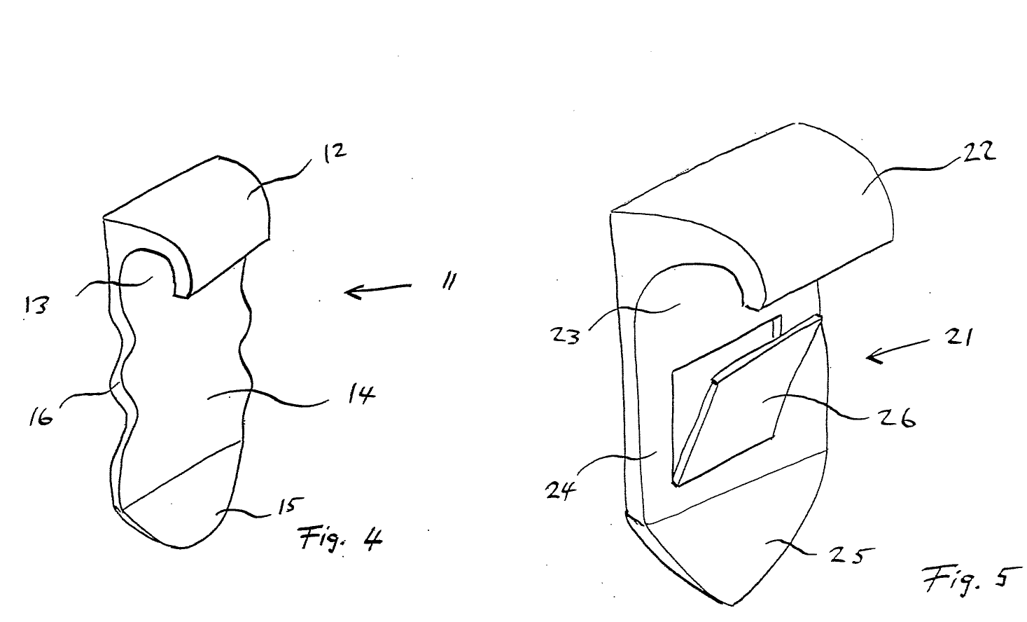

FIGS. 4 to 6 shows examples of alternative cable clips 11, 21, 31 according to the present invention, giving a retaining force when installed.

The cable clip 11 of FIG. 4 has a head 12 with a recess 13 to receive a cable, in the same way as for the cable clip 1 described above. Furthermore, the cable clip 11 has an insert part 14 with a bevelled lower end 15. The insert part 14 has one or more horizontal bends 16 between the head 12 and the bevelled end 15. The bends 16 are flexible to give a retaining force when installed, in the same way as described for the flexible parts 6 of the previously described embodiment.

The cable clip 21 of FIG. 5 has a head 22, a recess 23 and an insert part 24 with a bevelled lower end 25. A flexible part 26 in the form of a plate is formed on the insert part 24 of the cable clip 21. The flexible part 26 is placed approximately in the middle of the insert part 24, both in horizontal and vertical directions. In the shown embodiment there is an opening in the insert part 24, placed behind the flexible part 26. The flexible part 26 may be formed by punching out said part 26 from the insert part 24, which gives the opening indicated above. In other embodiments there is no opening in the insert part 24. Irrespectively of if there is an opening or not in the insert part 24 the flexible part 26 may be formed together with the cable clip 21 in many ways, e.g. in moulding. A person skilled in the art realises that the flexible part 26 may be directed either away from the wall 8 as shown or towards said wall 8. Furthermore, the size of the flexible part 26 may vary, as long as the retaining function is maintained.

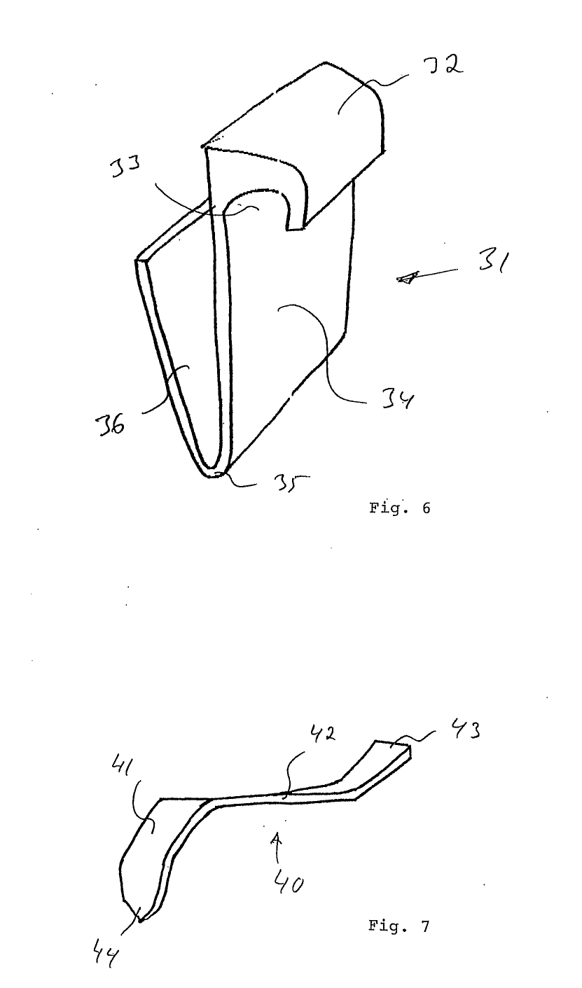

The cable clip 31 of FIG. 6 has a head 32 with a recess 33 for receiving a cable. The insert part 34 goes over into a flexible part 36 via a bent, rounded lower end 35. The flexible part 36 is directed away from the insert part 34 and is to be directed towards the wall 8 when installed. In an alternative not shown embodiment, the flexible part 36 is arranged on the same side as the head 32, i.e. to be directed towards the skirting board 7 when installed.

The cable clips 1, 11, 21, 31 of the present invention are preferably made of plastics and through injection moulding. However, a person skilled in the art realises that the cable clips 1, 11, 21, 31 may be formed by any material and by any method as long as each cable clip 1, 11, 21, 31 is possible to insert and gives a retaining force when installed. Also the special tool 40 is preferably made of plastic but may of course be made of any suitable material withstanding the bending force needed.

When a cable is to be installed the recesses 3, 13, 23, 33 of a number of clips 1, 11, 21, 31 are normally successively placed around the cable. It is also possible to first place the cable along the skirting board and then place the cable in the recess 3, 13, 23, 33 of each cable clip 1, 11, 21, 31 at the same time as the cable clip 1, 11, 21, 31 is inserted. Furthermore, it is also possible to let the cable clips 1, 11, 21, 31 slide along the cable to adjust the position of each cable clip 1, 11, 21, 31 e.g. depending on the available space between skirting board 7 and wall 8. With the cable in place each clip 1 is inserted between a skirting board 7 and a wall 8. Should the distance between the skirting board 7 and the wall 8 be too small the special tool 40 may be used to bend the skirting board outwards just enough to make it possible to insert the clip 1, 11, 21, 31. If needed a hammer may be used to gently force the tool 40 in between the skirting board 7 and the wall 8. Normally it is possible to use each insertion and bending of the tool 40 for a number of clips 1, 11, 21, 31 at a time. When installed the lower edge of the outer part of the head 2, 12, 22, 32 will normally be level with the upper edge of the skirting board 7 and, thus, the cable will be totally surrounded by the recess 3, 13, 23, 33 and the upper edge of the skirting board 7.

If the cable is to be taken away the cable clips 1, 11, 21, 31 are simply lifted up against the retaining force of the flexible parts 6, 16, 26, 36. Leaving no or virtually no marks on the wall 8 or skirting board 7.

1-9. (canceled)

10. A method of placing a cable at a skirting board, wherein cable clips holding the cable are inserted between the skirting board and a wall, at which the skirting board is placed, which cable clips have one or more flexible parts extending from the cable clips and giving a retaining force when installed and in that a tool is used to temporarily bend out the skirting board for insertion of one or more cable clips if needed.

11. A cable clip for insertion between a skirting board and a wall, wherein the cable clip comprises a head with a recess to receive a cable and an insert part and the cable clip has one or more flexible parts, directed forward or backward from the insert part and giving a retaining force after installation between the skirting board and the wall.

12. The cable clip of claim 11, wherein the lower end of the insert part is bevelled and/or pointed.

13. The cable clip of claim 12, wherein the cable clip has two flexible parts in form of a bendable strip at each side of the insert part and integrated with the insert part.

14. The cable clip of claim 12, wherein the cable clip has a flexible part in the form of plate arranged at the middle of the insert part.

15. The cable clip of claim 11, wherein the lower end of the insert part is rounded and in that the flexible part is in a form of a plate directed away from the insert part and integrated with the insert part via the lower end, the flexible part being directed upwards from the lower end.

16. The cable clip of claim 11, wherein the cable clip is made of plastic.

17. A tool to be used when installing a clip according to claim 12, wherein the tool has an insert part with a lower and bevelled pointed end, a horizontal part and a handle and that the handle is directed upwards and is placed at the opposite end of the insert part directed downwards.

18. The tool of claim 17, wherein the tool is made of plastic.
